(19) United States
(12) Patent Application Publication
(10) Pub. No.: US 2005/0110247 A1
(43) Pub. Date: May 26, 2005

(54) Airbag apparatus

(75) Inventors: Hidenobu Suzuki, Fujinomiya-shi (JP); Takashi Tokita, Fuji-shi (JP); Tsuyoshi Watanabe, Fujinomiya-shi (JP); Mikio Ochiai, Fuji-shi (JP)

Correspondence Address: DARBY & DARBY P.C., P. O. BOX 5257, NEW YORK, NY, 10150-5257, US

(73) Assignee: NIHON PLAST CO., LTD., Fuji-shi (JP)

(21) Appl. No.: 10/962,212

(22) Filed: Oct. 8, 2004

(30) Foreign Application Priority Data
Oct. 10, 2003 (JP) 2003-352450
Oct. 31, 2003 (JP) 2003-373276

(51) Int. Cl. B60R 21/20

(52) U.S. Cl. 280/728.3; 280/732

(57) ABSTRACT

An airbag that can easily restrain a pressure at an initial stage of expansion is to be provided. A case is designed to have a large width dimension. The width dimension is set to be not less than 2.0 times but not more than 3.0 times a width dimension of a head portion of an AC06 type dummy A for a vehicle collision experiment. Two disk-shaped inflators are attached to the base portion of the case. Even when the airbag is activated when the dummy A is close to a lid covering the airbag, the airbag can expand toward both sides of the dummy A, thereby easily alleviating an impact applied to the dummy A.

### INCORPORATION BY REFERENCE

The present application claims priority under 35 U.S.C. §119 to Japanese Patent Application Nos. 2003-352450 filed on Oct. 10, 2003 and 2003-373276 filed on Oct. 31, 2003. The contents of the applications are incorporated herein by reference in their entireties.

### BACKGROUND OF THE INVENTION

1. Field of the Invention

The present invention relates to an airbag apparatus, for example, for a passenger in a passenger seat of a vehicle.

2. Description of the Related Art

An airbag apparatus is conventionally known, which is provided in a steering wheel and/or an instrument panel to be inflated and expanded by a gas supplied from an inflator, for protecting a passenger from an impact of a collision (see, for example, Japanese Published Unexamined Patent Application No. 11-59306). The airbag apparatus for a passenger in a passenger seat provided in the instrument panel includes a folded airbag and a cylindrical inflator and is accommodated in a rectangular box shape casing (reaction can). Further, a passenger airbag apparatus has a larger capacity than a driver air bag apparatus installed in the steering wheel because the passenger airbag apparatus is located farther from the seated passenger to be protected and hence has to expand over a more extensive area. Also, for facilitating layout design of the instrument panel, a width dimension of the airbag apparatus is limited to, for example, not more than approximately 200 mm, which is smaller than substantially a half of the instrument panel width.

In order to achieve a desired expansion characteristic of an airbag on a passenger seat side installed under the foregoing condition, various measures have been taken such as employing a separate member for fastening a folded airbag, adjusting an inflator characteristic, or modifying a structure of a cover to enclose the folded airbag.

Also, such an airbag apparatus is known, that is longer and thinner to be accommodated in a limited space and, for example, that can be inflated so as to wrap around a passenger including a child who tends to be seated deviated from a seat center, to thereby maximize a passenger protecting opportunity (See, for example, Japanese Published Registered Utility Model Application No. 3013185).

However, such a structure only permits expanding a protection area in a widthwise direction of the vehicle, without offering a practical remedy for alleviating an impact or pressure imposed on a passenger to be protected, and thereby improving protection performance of the airbag apparatus.

Currently, there has been an increasing demand for further improvement that permits easily achieving a desired expansion characteristic.

The present invention has been conceived in view of the foregoing situation, with an object to provide an airbag apparatus that can easily achieve a desired expansion characteristic, to thereby easily alleviate an impact or pressure during an expanding process to an appropriate level.

### SUMMARY OF THE INVENTION

The present invention provides an airbag apparatus including an airbag to be inflated and expanded by an inflow of a gas; an inflator which supplies the gas to the airbag; and a case accommodating therein the airbag in a folded state and provided with an opening through which the folded airbag is to inflate outward, wherein a width dimension of the opening is not less than 2.0 times, but not more than 3.0 times of a width dimension of an object to be protected.

With such a construction, since a width dimension of the opening through which the folded airbag is to expand outward is set to be not less than 2.0 times the width dimension of the object to be protected, an initial expansion pressure is restrained, and also a portion of the expanding airbag not in contact with the object to be protected can smoothly keep expanding after the airbag has made contact with the object to be protected. Therefore, an impact applied to the object to be protected by the expansion of the airbag can be easily alleviated. In particular, even though the object to be protected is in a position close to the opening, an impact applied to the object to be protected by the expansion of the airbag can be easily alleviated. Also, setting a width dimension of the opening through which the folded airbag is to expand outward so as not to exceed 3.0 times the width dimension of the object to be protected can keep the dimensions of the case and the airbag from becoming oversized, and eliminate the need to increase an output of the inflator, thereby facilitating adjustment of the expansion characteristic.

The airbag apparatus of the present invention also provides the airbag as defined above installed in a vehicle oriented so as to oppose a passenger, with a widthwise direction thereof aligned with that of the vehicle, wherein the width dimension of the object to be protected is in accordance with a width dimension of a head portion of an AC06 type dummy for vehicle collision experiments.

With such a construction, the airbag apparatus for a vehicle attains an expansion characteristic appropriate for an object to be protected of a relatively small physique.

The airbag apparatus of the present invention also provides the airbag apparatus as defined above, further comprising a lid openably covering the opening of the case, wherein an area of the lid is not less than 26,000 mm² and not more than 60,000 mm².

Such a construction provides a sufficient width dimension and depth dimension to the lid, thereby facilitating the airbag in the case of pushing the lid to open by a relatively low pressure. Consequently, an expansion pressure can be alleviated and an impact to the object can be easily mitigated.

The airbag apparatus of the present invention also provides the airbag apparatus as defined above, wherein a maximum output of the inflator is not more than 380 kPa.

Such a construction permits the airbag to expand by a low pressure, thus easily reducing an impact applied to the object to be protected.

The present invention also provides the airbag apparatus as defined above, further comprising a plurality of inflators, wherein a maximum output of a first one of the inflators, to be initially activated when activating the inflators, is not more than 380 kPa.

Such a construction permits the airbag to expand by a low pressure, thus easily reducing an impact applied to the object to be protected.

As described above, the airbag apparatus according to the present invention can easily alleviate an impact applied to the object to be protected by the expansion of the airbag.

### BRIEF DESCRIPTION OF THE DRAWINGS

FIG. 1 illustrates a state and dimensions of a pre-expanded airbag apparatus according to an embodiment of the present invention;

FIG. 2 is a cutaway perspective exploded view showing the airbag apparatus of the present invention;

FIG. 3 is a cutaway perspective view showing a vehicle in which the airbag is installed;

FIG. 4 is a schematic plan view showing a state during an expansion of the airbag apparatus of the present invention;

FIG. 5(a) to FIG. 5(d) are explanatory illustrations showing an experiment of the airbag apparatus, where FIG. 5(a) shows a state of 0 ms after activation, 5(b) 15 ms after activation, 5(c) 20 ms after activation, and 5(d) 50 ms after activation of the airbag apparatus of the present invention;

FIG. 6(a) to FIG. 6(d) are explanatory illustrations showing an experiment of an airbag apparatus according to a comparative example, where FIG. 6(a) shows a state of 0 ms after activation, 6(b) 15 ms after activation, 6(c) 20 ms after activation, and 6(d) 50 ms after activation of the airbag apparatus;

FIG. 7 is a cutaway perspective exploded view of an airbag apparatus according to another embodiment of the present invention;

FIG. 8 is a top view showing a configuration of the inflators and the retainer indicating a gas blow of the airbag apparatus;

FIG. 9 is a side view showing a configuration of the inflators and the retainer indicating a gas blow of the airbag apparatus;

FIG. 10 is an explanatory drawing showing an expanding status and indicating a gas blow of the airbag apparatus; and

FIG. 11 illustrates a state and dimensional relationship of a pre-expanded airbag apparatus according to another embodiment of the present invention.

### DETAILED DESCRIPTION OF THE PREFERRED EMBODIMENT

Referring to the accompanying drawings, an airbag apparatus according to an embodiment of the present invention will be described hereunder.

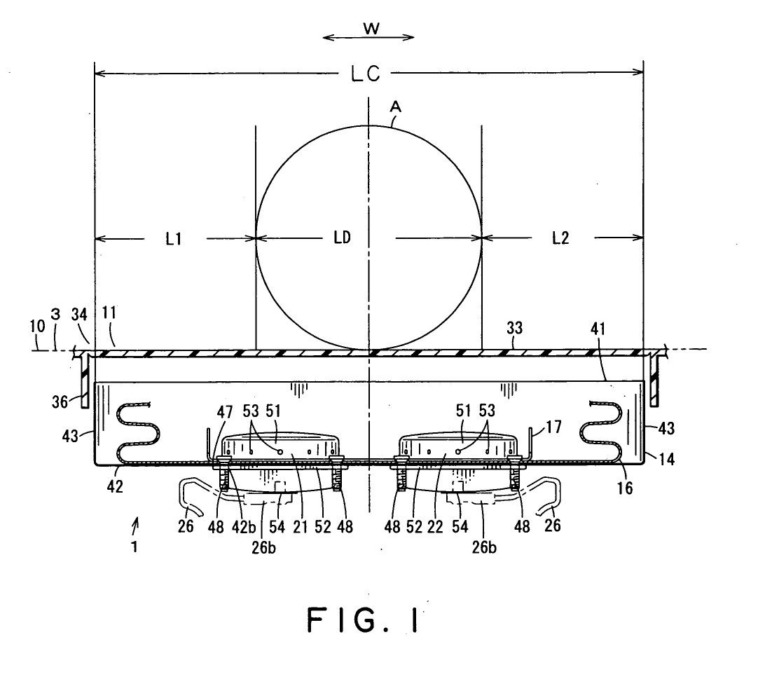

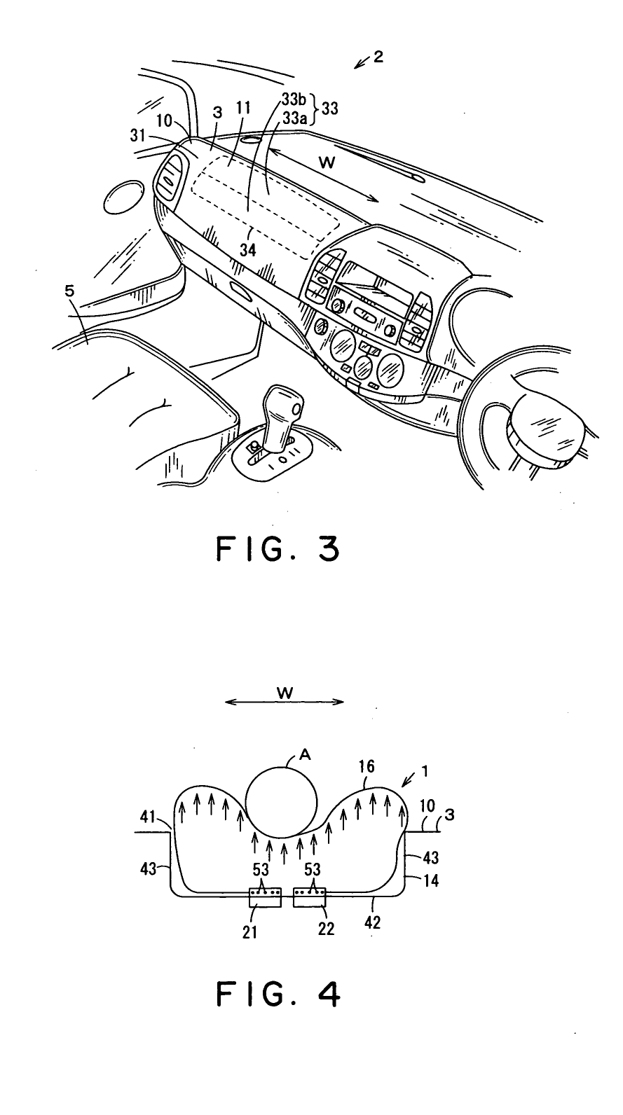

In FIG. 1 to FIG. 6, the reference numeral 1 designates the airbag apparatus, which is, as shown in FIG. 3, installed in an instrument panel 3 of a vehicle 2 which is the vehicle for a passenger, to serve as the passenger airbag apparatus 1 for protecting a passenger seated in the passenger seat, who is the object to be protected. More specifically, the instrument panel 3 is located in front of a seat 5 which is the passenger seat, and disposed with a longitudinal direction thereof aligned with a direction along the width dimension of the vehicle, specifically, the widthwise direction W, at a forward portion of the vehicle interior. Above the instrument panel 3 a front window glass is located, and a door constituting a side wall of the vehicle interior is provided in a direction along a lateral end portion of the instrument panel 3. Hereinafter, a direction along a moving direction when the vehicle 2 is proceeding straight will be defined as a back and forth direction, and a transversal direction orthogonal to the back and forth direction on a horizontal plane will be defined as a widthwise direction W.

Also, in the drawings an AC06 type dummy for vehicle collision experiments, specifically, a dummy A corresponding to a six-year-old American boy is used as the passenger, and a width dimension LD of a head portion of the dummy A is set at 135 mm.

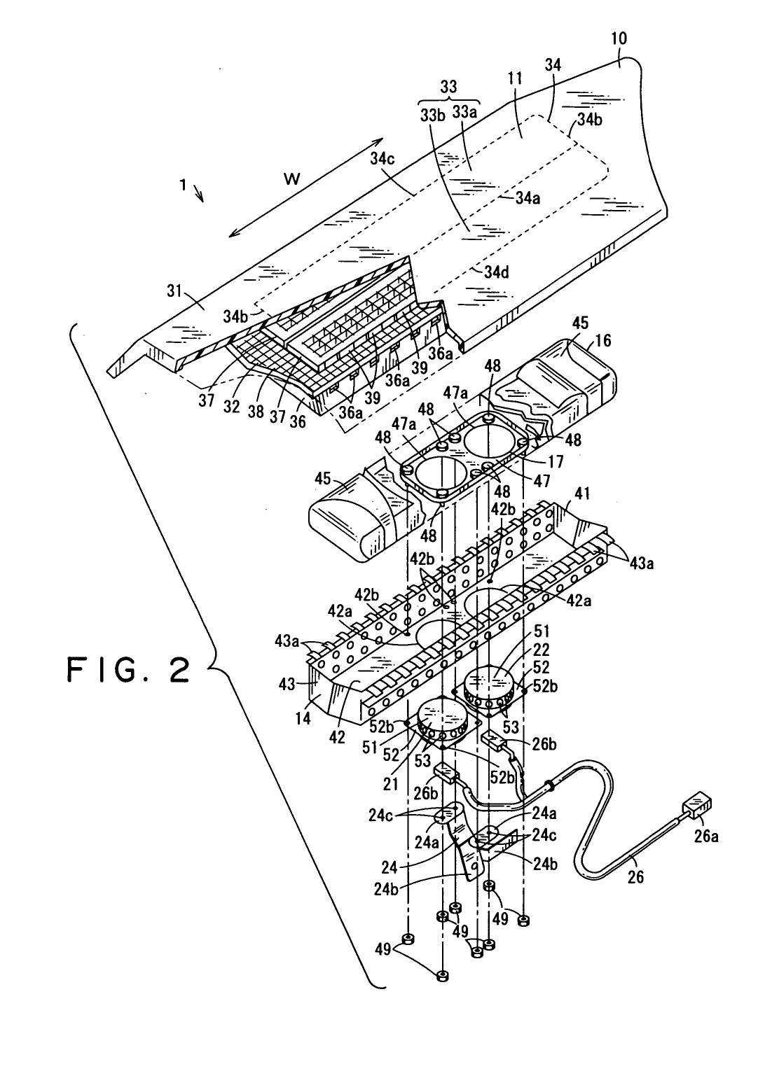

As shown in FIGS. 2 and 3, the airbag apparatus 1 includes a cover 11 formed on an upper panel 10 and an airbag module accommodated inside a rear face of the upper panel 10, and the airbag module is provided with a case 14 serving as a container, an airbag 16 to be placed in the case 14, a retainer 17, a first inflator 21 and a second inflator 22 constituting the inflators, a bracket 24, etc. Also, the airbag apparatus 1 is provided with a control unit and a sensor etc., though not shown in the drawings, electrically connected to the inflators 21 and 22 via a harness 26.

The cover 11 is formed in a unified body with the upper panel 10 constituting a so-called seamless instrument panel, and includes a surface panel 31 and a backing 32 unified with the surface panel 31 by ultrasonic welding. The surface panel 31 is made of, for example, a polypropylene (PP) resin, and integrally formed with a portion other than the cover 11 of the instrument panel, and a tear line 34 delineating a region to be broken corresponding to a lid 33 is formed in a recessed groove on a rear face of the surface panel 31. Here, the lid 33 according to this embodiment is formed of a pair of front and rear lids 33a, 33b disposed with a longitudinal side thereof aligned with a widthwise direction W, and a total area of the two lids 33a, 33b is set at 45,000 mm², with a width dimension of 375 mm and a depth dimension of 120 mm. And the tear line 34 includes a central tear line 34a oriented along a widthwise direction, a lateral tear line 34b extending forward and backward from the respective ends of the central tear line 34a, and a front tear line 34c and a rear tear line 34d connecting the front ends and the rear ends of the lateral tear lines 34b respectively, in compliance with the shape of the lids 33a, 33b. Also, the backing 32 includes a rectangular cylindrical shape box portion 36 integrally formed of a thermoplastic olefin (TPO resin) and arranged so as to surround a perimeter of the lid 33, a pair of front and rear lid supporters 37 arranged inside the box portion 36 and ultrasonically welded to a rear face of the lids 33a, 33b of the surface panel 31, a frame shape fixing portion 38 disposed outside the box portion 36 and ultrasonically welded to a rear face of the surface panel 31 except where the lids 33a,33b are located, and a plurality of bendable hinge portions 39 connecting the lid supporters 37 to the box portion 36. The box portion 36 is also provided with a plurality of square hook holes 36a formed on the front and rear sides thereof, for serving as an engaging hole. As well, the cover 11 is schematically illustrated in a simplified manner in FIG. 1.

The case 14 is formed of what is generally called a reaction can, made of iron plates appropriately bent and welded so as to form substantially a box shape having an opening 41 facing upward, a base portion 42 oriented with its longitudinal side aligned with a widthwise direction W and lateral wall portion 43 upwardly erected from a peripheral portion of the base portion 42. Here, referring to inner dimensions of the case 14, a length of a longitudinal side thereof, specifically, a width dimension LC is 365 mm, which is considerably longer than a conventional dimension of approximately 200 mm, while a widthwise length, specifically, a back and forth dimension is 110 mm, which is similar to a conventional dimension. The base portion 42 is provided with two circular holes defining inflator attaching regions 42a disposed side by side in a widthwise direction. Also, four attaching holes 42b are provided around the respective inflator attaching regions 42a. Further, the lateral wall 43 is provided with a plurality of hooks 43a to be engaged with the square hook holes 36a.

The airbag 16 is formed of one or more pieces of base cloths sewn so as to form a long bag shape, and is provided with two circular holes at positions corresponding to the respective inflator attaching regions 42a and a total of eight attaching holes at positions corresponding to the respective attaching holes 42b, formed on a base portion not shown in the drawings. The airbag 16 is folded and held by a wrapping 45 so as to keep its shape.

The retainer 17 is provided with a retainer base portion 47 of a rectangular plate shape, inserted in the airbag 16 and superposed on an upper face of the base portion 42. And the rectangular plate shape retainer base portion 47 is provided with two circular holes 47a at positions corresponding to the respective inflator attaching regions 42a and a total of eight fastening bolts 48 fixed at positions corresponding to the respective attaching holes 42b, to be inserted thereto. To these fastening bolts 48, a nut 49 is thread-fitted from a lower direction and fastened.

The bracket 24 is made of a metal plate or the like, and includes a case attaching portion 24a to be butted to a rear face of the base portion 42 of the case 14, and a body-side attaching portion 24b to be attached to the vehicle body. Also, the case attaching portion 24a is provided with an attaching hole 24c at a position corresponding to a part of the attaching holes 42b of the base portion 42 of the case 14.

The first and the second inflators 21, 22 are of an identical disk shape, and respectively include an inflator main body 51 of a flat cylindrical shape and a flange portion 52 projecting from an outer circumferential surface of the inflator main body 51. Each of the inflators is also provided with a plurality of gas injection outlets 53 on an outer circumferential surface of the inflator main body 51 in an upper region of the flange portion 52. A diameter of the inflator main body 51 is slightly smaller than that of the inflator attaching regions 42a, for example, 70 mm. The flange portion 52 of each inflator is provided with four attaching holes 52b at positions corresponding to the attaching holes 42b. Further, the inflator main body 51 is provided with a connector 54 for connection with the harness 26.

The first and the second inflators 21, 22 are provided with the same or mutually different characteristics, to thereby achieve a desired composite output upon being activated either simultaneously or with a predetermined time delay. According to this embodiment, the first and the second inflators 21, 22 have mutually different characteristics, in terms of initial time-pressure characteristic, generally called a rising characteristic, and are scheduled to be activated with a predetermined time delay, for example, 40 ms. More specifically, a second time-pressure characteristic of the second inflator 22 is designed in a steep inclination, such that a pressure increase in a shorter time compared with a first time-pressure characteristic of the first inflator 21 is provided. And a maximum (peak) output of the respective second inflators 21, 22 is set to be not more than 380 kPa, more preferably not more than 300 kPa. According to this embodiment, a maximum output of the second inflator, which is activated first, is set to be not more than 380 kPa, for example, it is set at 250 kPa. Here, the inflators 21, 22 may be grouped such that one is a standard article having an ordinary characteristic, and the other is a specially tuned customized article from the standardized article.

The harness 26 is a bundle of a plurality of core wires and provided with a connector 26a on an end portion thereof to be connected to the control unit, and branched two connectors 26b on the other end portion to be respectively connected to the connectors 54 of the first and the second inflator 21, 22. The control unit is a so-called electronic control unit (ECU), provided with a built-in CPU (central processing unit), a ROM, etc., and is connected to a sensor (not shown) serving as a detecting unit.

And, for assembling the airbag apparatus 1, first the retainer 17 is inserted into the airbag 16 and the circular holes 47a of the retainer 17 and those of the base portion of the airbag 16 are mutually positioned, and the airbag 16 is folded in a predetermined shape with the fastening bolts 48 drawn out from the attaching holes, and then the folded airbag 16 is held by the breakable wrapping 45. Then the folded airbag 16 is placed in the case 14, and the fastening bolts 48 projecting from the airbag 16 are inserted into the respective attaching holes 42b of the case 14.

After that, the inflator main bodies 51 of the respective inflators 21, 22 are inserted inside the airbag 16 through the respective inflator attaching regions 42a from a rear face of the case 14, and the fastening bolts 48 are inserted into the respective attaching holes 52b. Then the retainer attaching portion 24a of the bracket 24 is applied to the flange portion of the inflators 21, 22 from below and the four fastening bolts 48 disposed in a central region are respectively inserted through the attaching holes 24c. Under this state, once the nuts 49 are screw-fitted to the fastening bolts 48 from a tip portion thereof, the airbag 16, the retainer 17, the first and the second inflators 21, 22 and the bracket 24 are fixed to the case 14, thus constituting the airbag module.

Then the airbag module is brought to a rear face of the cover 11 of the instrument panel 3, and the hooks 43a are respectively engaged with the square hook holes 36a of the cover 11 so as to attach the airbag module to the cover 11, and also the body-side attaching portion 24b of the bracket 24 is fixed to a reinforcing member of the vehicle body or the like, to thereby complete the installment of the airbag apparatus. Meanwhile, the control unit may be disposed at an appropriate position of the vehicle body, to then be connected via the harness 26 to the inflators 21, 22 and to the sensor arranged at a predetermined position to serve as an impact sensor.

In the case where the vehicle provided with the airbag apparatus 1 collides, the control unit first activates the second inflator 22 based on the impact detected by the impact sensor among the respective inflators 21, 22, and after a predetermined time the control unit activates the first inflator 21, so that the airbag 16 is inflated outward by a gas supplied from the inflators 21, 22 and breaks the cover 11 by the expanding pressure to form a projecting outlet of the air bag 16, with a substantial center line of expansion oriented in a predetermined direction and to inflate and expand in front of the passenger for protecting him/her.

Next, an expanding operation of the airbag 16 in the case where the dummy A, the object to be protected, is very close to the airbag apparatus 1 will be described hereunder.

FIG. 1 illustrates a configuration and dimensions of the pre-expanded airbag apparatus; FIG. 4 is a schematic plan view showing a state during an expansion;

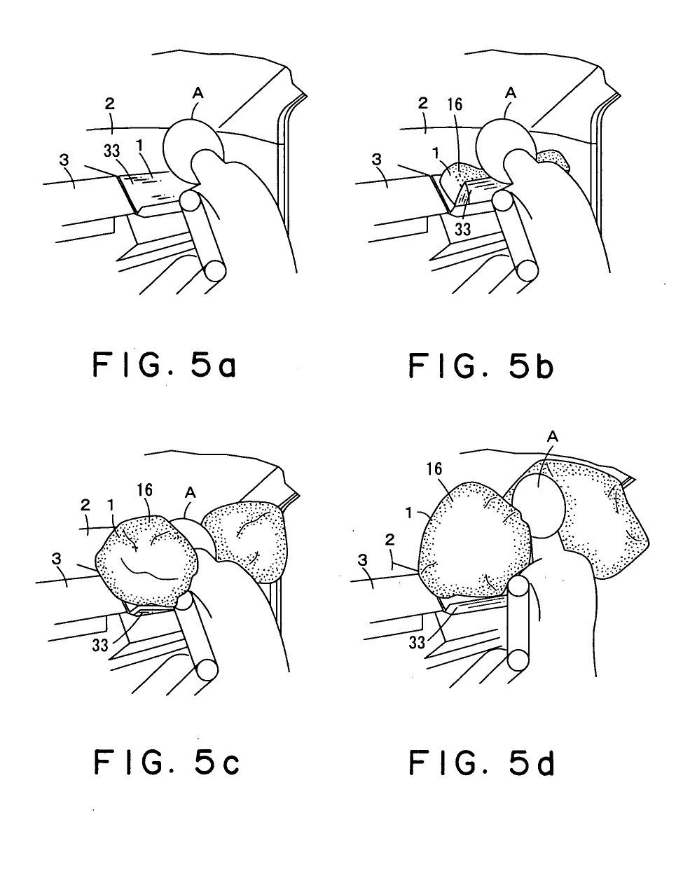

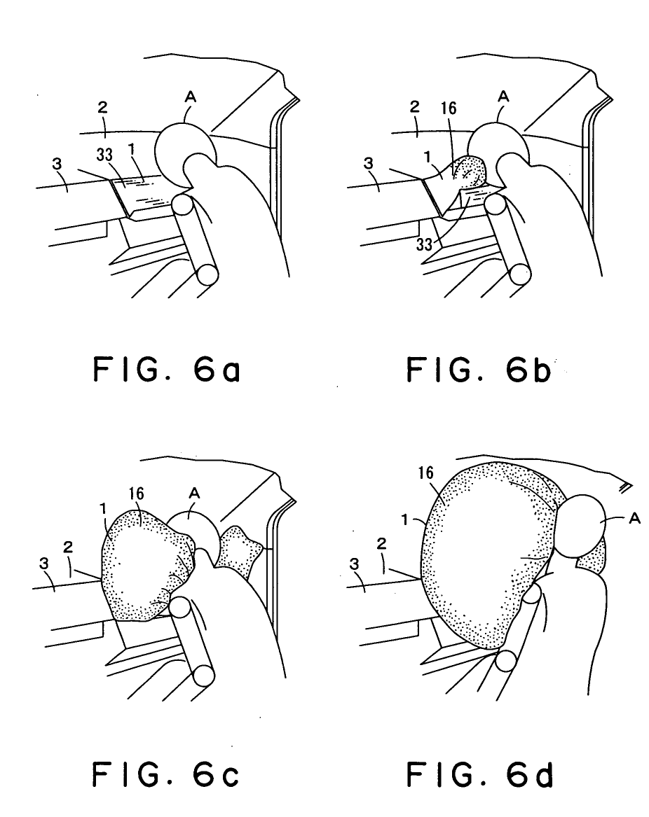

FIG. 5(a) to FIG. 5(d) show an experiment result of the airbag according to this embodiment and FIG. 6(a) to 6(d) show an experiment result of a comparative airbag example. In FIG. 5 and FIG. 6 respectively, (a) shows a state of 0 ms after activation of the inflators 21, 22 of the airbag apparatus 1, and likewise (b) for 15 ms, (c) for 20 ms and (d) for 50 ms.

As shown in FIG. 1, the width dimension LC of the case 14 of the airbag apparatus 1 according to this embodiment is set at 365 mm, while the width dimension LD of the head portion of the dummy A is 135 mm, therefore, even when the head portion of the dummy A comes close to a surface of the cover 11, a portion Lf (=L1+L2) of 230 mm which is not blocked by the head of the dummy A can be secured. On the other hand, a width dimension of a conventional case is approximately 200 mm; therefore the dimension Lf can only be approximately 65 mm. Accordingly, the value of Lf can be increased by as much as 165 mm.

Accordingly, in this embodiment the dimension Lf not blocked by the head of the dummy A has a sufficient length when the airbag 16 expands; in other words, a sufficient portion of the airbag 16 can inflate and expand without being obstructed by the dummy A, as shown in FIG. 4. For this reason, it can be confirmed according to FIG. 5(a) to FIG. 5(d) that an angle of the head portion of the dummy A with respect to its body portion does not vary so much with the lapse of time, in other words the dummy A inclines backward keeping an original posture along with the expansion of the airbag apparatus 1, instead of violently inclining backward.

By contrast, in the case of the comparative example in which the width dimension LC of the case 14 is set at 220 mm, an angle of the head portion of the dummy A with respect to its body portion largely varies with the lapse of time.

Consequently, with respect to the airbag apparatus 1 for a vehicle including the case 14 accommodating therein the folded airbag 16, designed to inflate and expand with a gas supplied by the inflators 21, 22, increasing a width dimension of the case 14 permits restraining a pressure at an initial stage of the expansion, and easily maintains a low pressure all through the expansion. Also, a portion of the airbag 16 not blocked by the head of the dummy A can be increased, resulting in alleviation of an impact imposed on the dummy A.

As a result of the experiment, it has been proven that setting the width dimension LC of the case 14 in a widthwise direction W of the vehicle 2 to be not less than 2.0 times (270 mm) the width dimension LD (135 mm) of the head portion of the AC06 type dummy A for collision experiments permits restraining a pressure at an initial stage of the expansion, and easily maintains a low pressure all through the expansion, and effectively alleviates an impact imposed on the dummy A because of increasing a portion of the airbag 16 not blocked by the head of the dummy A at the time of expansion.

On the other hand, setting the width dimension LC of the case 14 to be not more than 3.0 times (405 mm) of the width dimension LD of the head portion of the dummy A permits easy installation of the airbag apparatus 1 in the instrument panel 3, and eliminates the need to make a width dimension of the airbag 16 larger than a conventional one. As a result, an inflator of a similar output to a conventional one can be employed as the inflators 21, 22; therefore the manufacturing cost can be reduced. Here, in the event of employing a much larger airbag in combination with an inflator of a greater output, it becomes difficult to uniformly expand the airbag with a gas injected from the inflator, which is not desirable. Accordingly, an inexpensive airbag 16 popularly available can be employed in the airbag apparatus 1, which also leads to a reduction in the manufacturing cost. Meanwhile, in this embodiment two disk-shaped inflators 21, 22 are employed, and therefore a shape of the opening of the airbag 16 through which to introduce a gas is different from that of an airbag apparatus including a single cylindrical (round bar shape) inflator disposed with its longitudinal side aligned as a widthwise direction.

Referring to dimensions of the lid 33 that satisfy the foregoing conditions, based on the configuration according to this embodiment, in which dimensions of the opening 41 of the case 14 and those of the lid 33 are substantially the same, or at least a dimension along a widthwise direction W is substantially the same, and a dimension of each side of the lid 33 (width 375 mm, back and forth 120 mm) is set to be, for example, 5 mm longer than that of the opening 41 of the case 14 (width 365 mm, back and forth 110 mm), it is preferable to set an area of the lid 33 to be in a range of 26,000 mm² to 60,000 mm².

Also, because of employing the low-power inflators 21, 22, and by setting a peak output of a single inflator to be activated first, for example, not to exceed 380 kPa, more preferably not to exceed 300 kPa, a lower pressure is applied to open up the lid 33, and an impact value (Nij) to the dummy A can be reduced, to thereby prevent only the head portion of the dummy A from being roughly bent backward.

Further, the respective inflators 21, 22 are programmed to be activated with a fixed time delay of 40 ms, without involving a sensing means for detecting a position of the dummy A or a judgment means. Since it is possible to protect the dummy A, the object to be protected, under an appropriate characteristic regardless of a position of the dummy A, an airbag apparatus of a desirable characteristic can be easily constructed in a simplified structure, without the need to employ an expensive and complicated system provided with a plurality of preprogrammed modes to be selected depending on a position of the dummy A, and a function of making a decision based on given conditions and thereby selecting an appropriate predetermined mode; therefore, further, the manufacturing cost can be reduced, yet product reliability can be improved.

Also, according to this embodiment a plurality of disk-shaped inflators 21, 22 are employed, which are disposed in a central portion of the airbag apparatus 1 in its longitudinal direction, specifically, a widthwise direction W.

Accordingly, the case 14 can be formed in a flat shape except for the projections of a lower portion of the inflators 21, 22 in a central portion thereof, compared with the case of employing a cylindrical inflator; therefore the case 14 only secures a predetermined shallow region from the surface inside the instrument panel 3, which facilitates the layout adjustment of parts inside the instrument panel 3, such as distribution of an air-conditioning duct. Further, though a projected area of the case 14 may appear larger when viewed from the passenger's position, the volume does not increase in proportion with the projected area; therefore as a reflective effect a sufficient space can be secured in the case 14 for accommodating the airbag 16, so that the airbag 16 can be stored in a loosely folded shape. The folding capacity of the airbag 16 becomes easier thereby the work efficiency is improved, which also keeps the airbag 16 from being damaged. Further, since the airbag 16 widely expands with a low pressure, a load level imposed on an inner and outer portion of the airbag 16 can be lowered, which eliminates the need to provide a heavy reinforcement and hence reduces the manufacturing cost.

Also, a single airbag 16 is inflated utilizing a plurality of inflators 21, 22, or more specifically by a combination of the inflators 21, 22 having mutually different initial time-pressure characteristics (so-called rising characteristics) selected among those of various initial time-pressure characteristics in accordance with the purpose. Therefore, the manufacturing cost can be reduced and yet a desirable rising characteristic for a system can be easily achieved, compared with the case of employing a single inflator or a plurality of inflators of the same characteristics.

Further, a desired time-pressure characteristic can be easily attained for an entire system by simultaneously activating a plurality of inflators to attain a desired time-pressure characteristic for the entire system, or activating one or another of a plurality of inflators with a time delay to thereby obtain a composite output formed of shifted curves of the time-pressure characteristics.

And the simultaneous activation mode and the time-delay activation mode can be optionally selected through a control by the control means.

Further, the airbag apparatus may be provided with a plurality of inflators which supply a gas, an airbag to be inflated outward by the gas supplied by the inflators, and a shielding means which shields a part of the gas injected by one of the plurality of inflators toward another of the same.

In the case of employing a plurality of inflators, a flow of the gas injected by one of the inflators is biased by another inflator. However, employing a shielding means permits controlling the gas flow, and thereby easily achieving a desired expansion characteristic.

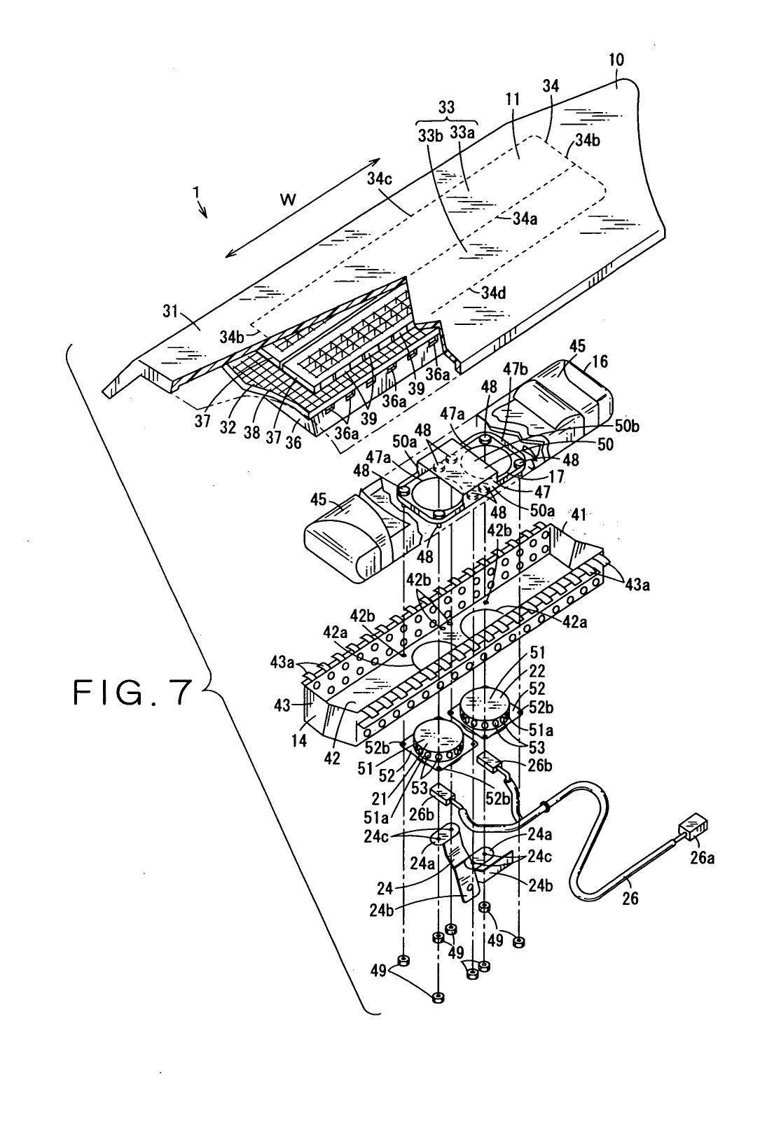

An embodiment according to such a structure will be described referring to FIG. 7 to FIG. 10.

As shown in FIG. 7 to FIG. 9, the retainer 17 includes a retainer peripheral wall 47b, formed by upwardly bending a peripheral part of the retainer base portion 47. A shielding plate 50, integrally formed with related parts to serve as the shielding means, is provided at a central portion of the retainer base portion 47 in a widthwise direction W. The shielding plate 50 covers a part of a region above the retainer base portion 47. In this embodiment, the shielding plate 50 includes an end plate 50a, 50a and a controlling plate 50b, and is formed substantially in an overturned U-shape in a side view. The end plate 50a is disposed at a central portion of the retainer peripheral wall 47b in a widthwise direction W, so as to extend therefrom. The controlling plate 50b is formed so as to bridge between uppermost edges of the end plates 50a, 50a. The control plate 50b covers at least a part of the circular hole 47a, 47a located on both sides thereof, for example approximately half an area of the respective holes 47a, as in this embodiment.

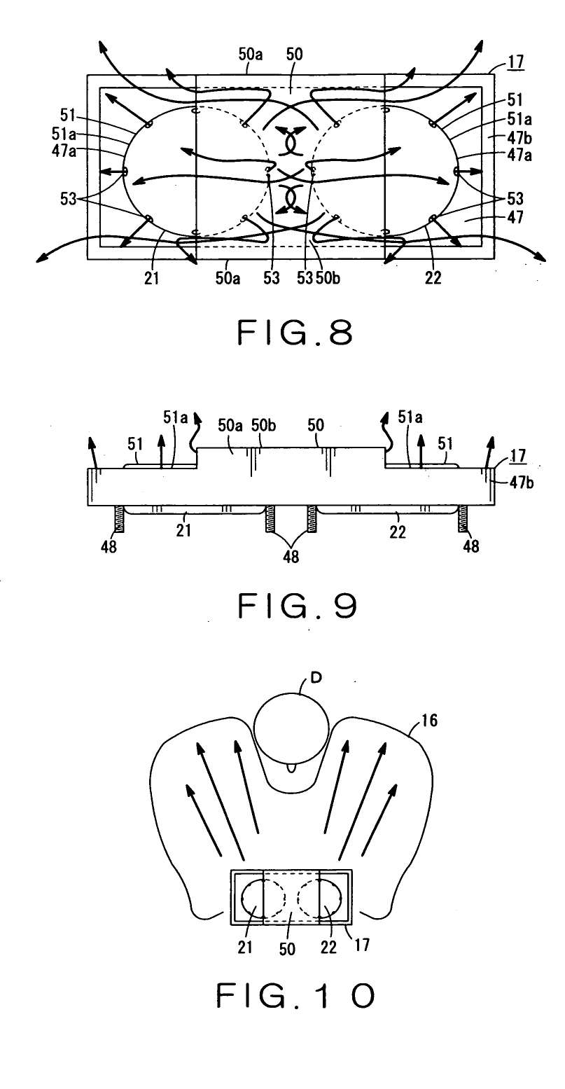

When the respective inflators 21, 22 are activated, the gas is injected in a radial direction from a gas injection nozzle 53 of the respective inflators 21, 22, as shown by the arrow in FIG. 8. In other words, the gas is injected in a direction orthogonal to an expanding direction of the airbag 16. In a region where the inflators 21, 22 are opposite, the gas injected from one of the inflators 21, 22 collides with a circumferential wall 51a of the other inflators 21, 22 and diffuses to thereby cause a turbulent flow, to be further guided and controlled along an inner face of the shielding plate 50 and to blow toward the both sides thereof. In this way, a gas blow emerges in a region not covered with the shielding plate 50 as well as in an exterior region of the both sides, specifically, on the left and right sides of the shielding plate 50, as shown in FIG. 8 and FIG. 9.

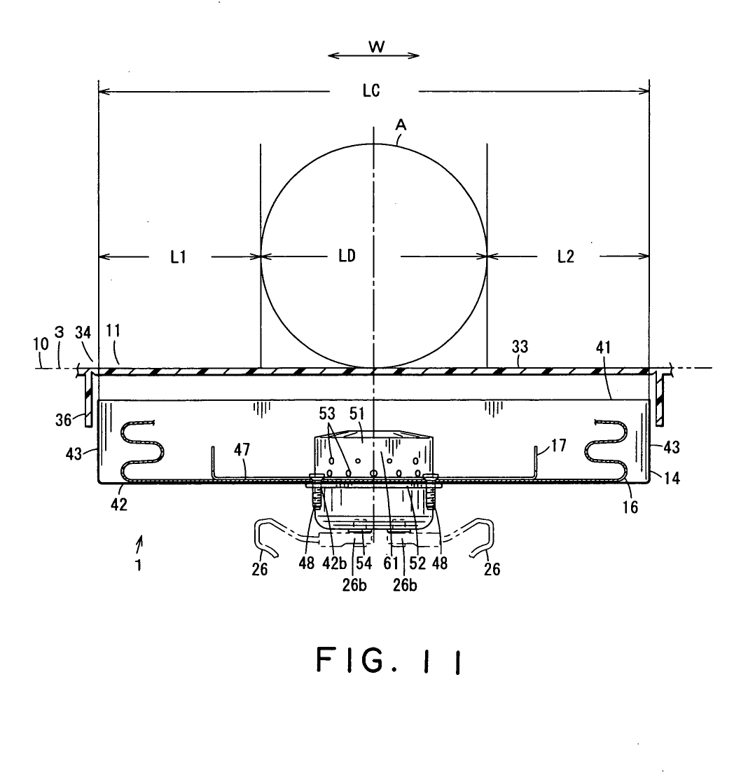

As a result, the gas is guided and controlled such that rather a split flow in the lateral regions on both sides constitutes a main stream rather than a flow of a central region as shown in FIG. 10; therefore the gas blow does not concentrate in a central region.

According to this embodiment, in the airbag apparatus 1 provided with a plurality of inflators 21, 22 which supply the gas to the folded airbag 16 to inflate and expand the airbag 16, the shielding plate 50 covers a region where the plurality of inflators 21, 22 are opposite, specifically, where the gas blow injected from the gas injection nozzle 53 of one of the inflators 21, 22 collides with a peripheral wall 51a of the other inflators 21, 22. Therefore, local concentration of the heat gas blow can be restrained and a desirable expansion characteristic can be easily attained. For example, a bias of the gas blow such as the concentration of the gas blow in a central region between the inflators 21, 22 can be easily restrained. Consequently, even when the dummy D is very close to the airbag apparatus 1, an impact applied to the dummy D can be easily alleviated.

Further, controlling the gas blow by the shielding plate 50 permits forming a stable gas blow regardless of an activating mode of the inflators 21, 22. Specifically, it is primarily a pressure characteristic that varies depending on the activating timing of the inflators 21, 22, and factors other than the pressure characteristic, such as a direction of the gas blow, can therefore be stabilized by the shielding plate 50.

While two inflators 21, 22 are employed in the foregoing embodiment, without limitation thereto a single inflator having a maximum output not exceeding the value defined above may also be set. Also as shown in FIG. 11, an inflator 61 seemingly formed as a single inflator but including a plurality of squibs (ignition device) may be employed. The inflator 61 is a so-called twin squib type which includes therein two squibs and to which two harnesses 26 are connected. The squibs may be activated with a predetermined time delay so as to simulate a case where two inflators are employed. The inflator 61 may be of a disk shape or a bar shape cylinder type inflator provided therein with a plurality of squibs. Further, three or more inflators may be employed. In the case of employing three or more inflators, each of the inflators may have a different characteristic from one another, or alternatively a plurality of inflators among an entirety may have the same characteristic. Also in this case, each of the inflators may be activated at a different timing from one another, or alternatively a plurality of inflators among an entirety may be controlled as a group and simultaneously activated. In this way, employing a group of inflators in various combinations permits easily achieving a desired system characteristic (time-pressure characteristic).

Still further, the plurality of inflators may include inflators of a different shape from one another, without limitation to employing those of the same shape. Also, without limitation to a combustion type (pyro-type) inflator, various other types such as a compressed gas type, a hybrid type and etc., may be employed with regard to respective inflators. Each of the inflators may be formed of a unified body or a combination of a plurality of parts. For example, an inflator main body which generates a gas may be combined with a guiding body which leads the gas to a certain direction, to inject the gas toward a desired direction.

Still further, according to the foregoing embodiment the airbag apparatus is disposed in the instrument panel 3 with its longitudinal side aligned with a widthwise direction W of the vehicle 2, so as to oppose a passenger in the passenger seat, however, without limitation to such a construction, the airbag apparatus may be installed in a rear face of the front seat for a passenger in the rear seat, or may be disposed with its longitudinal side aligned with a back and forth direction along a straight forward moving direction of the vehicle, so as to oppose a lateral side of a passenger.

Furthermore, among the dummies for the vehicle collision experiment, an AC03 type dummy which has a head portion of 135 mm in the width dimension, and an AF05 type dummy which has a head portion of 140 mm in width dimension are known as a dummy of a similar size, in addition to the AC06 type having a head of 135 mm in width dimension. A similar design may be applied to the airbag apparatus with respect to these dummies. Also, in the case where relatively small dummies in comparison to these do not have to be considered from the point of view of vehicle design, for example, the case where the vehicle is only intended for use by adults, a larger dummy such as type AM50 which has a head portion of 150 mm in the width dimension may be applicable to the concept of the present invention, to thereby appropriately determine a width dimension of the opening of the case.

In the aspect of an industrial applicability, the airbag apparatus according to the present invention may be utilized in other transportation media such as a vessel or an aircraft, in addition to a vehicle.

1. An airbag apparatus comprising:
an airbag inflated and expanded by an inflow of a gas;
an inflator supplying said gas to said airbag; and
a case accommodating therein said airbag in a folded state and provided with an opening through which said folded airbag is to inflate outward,
wherein a width dimension of said opening is not less than 2.0 times, but not more than 3.0 times the width dimension of an object to be protected.

2. An airbag apparatus according to claim 1 to be installed in a vehicle, arranged in a widthwise direction thereof aligned with that of said vehicle,
wherein a width dimension of said object to be protected is in accordance with a width dimension of a head portion of an AC06 type dummy for a vehicle collision experiment.

3. An airbag apparatus according to claim 1, further comprising a lid openably covering said opening of said case, wherein an area of said lid is not less than 26,000 mm² but not more than 60,000 mm².

4. An airbag apparatus according to claim 1, wherein a maximum output of said inflator is not more than 380 kPa.

5. An airbag apparatus according to claim 1, comprising a plurality of inflators,
wherein a maximum output of a first one of said inflators, to be initially activated when activating said inflators, is not more than 380 kPa.
